(19) United States
(12) Patent Application Publication
(10) Pub. No.: US 2022/0071369 A1
(43) Pub. Date: Mar. 10, 2022

(54) Device for Cosmetic Application and Method for Production of Such a Cosmetic Product Application Device

(71) Applicant: Parfums Christian Dior, Paris (FR)

(72) Inventors: Benoit Fuchs, Saint Ouen (FR); Noel Autie, Thials (FR)

(73) Assignee: Parfums Christian Dior, Paris (FR)

(21) Appl. No.: 17/416,156

(22) PCT Filed: Dec. 10, 2019
(86) PCT No.: PCT/FR2019/052985

§ 371 Date: Jun. 18, 2021

(30) Foreign Application Priority Data
Dec. 18, 2018 (FR) 18 73246

(51) Int. Cl. A45D 34/04; A46B 9/00; B29C 44/12; B29C 44/34

(52) U.S. Cl. CPC A45D 34/04; A46B 9/005; B29C 44/1276; B29L 2031/718; A45D 2200/1009; A46B 2200/1046; A46B 2200/1053; B29C 44/3415

(57) ABSTRACT

A cosmetic product application device comprising a holding member and an applicator element secured to the holding member. The applicator element is at least partially foamed plastic. The application device may be part of a cosmetic product packaging and application assembly.

### FIELD OF THE INVENTION

The present description relates to a cosmetic product application device, a packaging and application assembly comprising such an application device, and methods for production of such a cosmetic product application device and such a packaging and application assembly.

### DESCRIPTION OF RELATED ART

Many cosmetic product application devices have already been described.

For example, DE 20 2007 014,474 U1 describes an application device whose applicator element is made of two materials, one harder material and one softer material, overmolded around the harder material. The softer material is overmolded on the harder material so as to form an anchoring part in the harder material. The applicator element described in DE 20 2007 014,474 U1 has a satisfactory mechanical resistance, because of the harder material part, in order to provide for precision in the application of the cosmetic product, while retaining a good usage comfort, because the softer material part, which is intended to be in contact with the user's skin.

Additionally, EP 2,647,479 A1 describes an injection molding method for plastic material with which to get a part of foamed thermoplastic. According to this document, such a piece may in particular be implemented in the automotive field.

### BRIEF SUMMARY OF THE INVENTION

The goal of the present description is to provide an application device having better comfort for the user, while also retaining a high precision in use. Another goal of the present description is to provide a production method for such an applicator device, requiring the fewest possible steps while also make it possible to get an aesthetic result.

For this purpose, a cosmetic product application device is described that comprises a holding member and an applicator element secured to the holding member, in which the applicator element is at least partially in foamed plastic.

Thus, the applicator element is made in whole or in part of foamed plastic, a material which has a feel found to be particularly agreeable by users.

According to the preferred embodiments, the cosmetic product application device has one or more of the following features, taken alone or in combination:

the applicator element is connected to the holding member by a stem;

the applicator element comprises a rigid head onto which an application part of foamed plastic is overmolded;

the rigid head and the application part are fixed to each other by interlocking shape and/or by adhering;

the rigid head has an internal connecting area receiving an anchoring portion of the application part;

the internal connecting area of the rigid head comprises at least one channel, preferably two channels, where the or each channel extends again preferably along a first longitudinal segment opening into a longitudinal end of the rigid head and along a second radial section, opening onto a lateral side of the rigid head;

the rigid head is jointly molded with the stem;

the foamed plastic is selected from:
Versaflex™ CL30 thermoplastic elastomer from PolyOne™ Corporation;
TM3 ADT thermoplastic elastomer from KRAIBURG TPE;
Versaflex™ 2000x thermoplastic elastomer from PolyOne™ Corporation;
Versaflex™ PKG4365 thermoplastic elastomer from PolyOne™ Corporation;
TF5 FMA thermoplastic elastomer from KRAIBURG TPE;
any thermoplastic which can have chemical flow readhesion with the rigid head, as needed; and

the application device is selected from:
a gloss applicator;
a mascara applicator; and
an eyeshadow applicator.

According to another aspect, a cosmetic product packaging and application assembly is described comprising an application device such as described above in all combinations thereof, and a container intended to contain a cosmetic product to be applied by means of the application device, where the application device is preferably suited to be fixed on the container such that the applicator element is received inside the container.

Preferably, the container contains a cosmetic product, where the cosmetic product is preferably selected from:
gloss;
mascara; and
eyeshadow.

The container may have an opening, preferably just one, and the holding member may be suited to be fixed onto the container in order to block the opening of the container, preferably in a position of the application device such that the applicator element is in contact with the cosmetic product contained in the container.

Additionally, a method for production of an application device such as described above in all combinations thereof, is described comprising:

i) supplying a holding member;
ii) implementing the applicator element; and
iii) attaching the applicator element to the holding member;
method in which the implementation of the applicator element comprises:
a) injecting liquid plastic and gas into a mold in order to implement a foamed plastic; and
b) after cooling, withdrawing the foamed plastic part made in step a) from the mold, where the part forms all or part of the applicator element.

In step a), the mold may be heated, in particular a surface of the mold may be heated, which defines an application surface of the applicator element or the application part, as needed.

During step a), a portion of the gas present in the mold may be evacuated.

The application part in foamed plastic may be overmolded on the rigid head.

In step a), a quantity of material less than the volume of the mold to be filled with said material can be injected, where the ratio between the quantity of material injected and the volume of the mold to be filled is preferably included between 90% and 95%.

The method may comprise, after the injection step, a step of holding the mold in the closed state for a rest time at least greater than the length of the injection step, where the rest time is advantageously over 5 seconds.

The gas may be selected from:

nitrogen; and

carbon dioxide.

A method for production of a cosmetic product packaging and application assembly such as described above in all combinations thereof, comprises:

producing an application device by implementing a method such as described above in all combinations thereof; and

supplying a container suited to contain the cosmetic product.

This method may further comprise attachment of the application device onto the container.

### BRIEF DESCRIPTION OF THE DRAWINGS

The invention will be better understood from the following description made with respect to the attached drawings, in which:

FIG. 1 is a partially detached view of a cosmetic product packaging and application device with a cosmetic product application device;

FIG. 2 is a side view of the applicator element from the cosmetic product application device from FIG. 1;

FIG. 3 is a section view of the applicator element from FIG. 2 along the section plane III-III;

FIG. 4 is a section view of the applicator element from FIG. 2 along the section plane IV-IV;

FIG. 5 shows a first step of a method for production of an applicator element according to FIG. 2;

FIG. 6 shows a second step of a method for production of an applicator element according to FIG. 2; and

FIG. 7 shows a third step of a method for production of an applicator element according to FIG. 2.

### DETAILED DESCRIPTION OF THE INVENTION

In the remainder of the description, the elements which are identical or have an identical function bear the same reference sign. For the purpose of conciseness of the present description, these elements are not described in the context of each embodiment. Instead, only the differences between the embodiments are described.

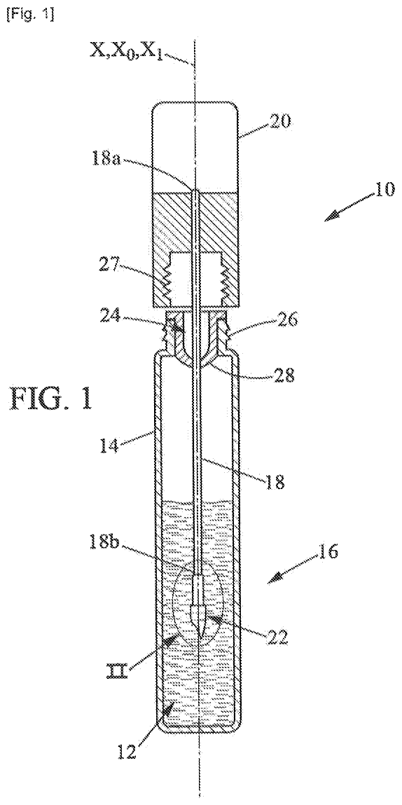

FIG. 1 shows a device 10 for packaging and application of a cosmetic product 12. The cosmetic product 12 is for example eyeshadow.

Alternatively, the cosmetic product 12 is selected from:

gloss;

mascara;

a powder;

a care product.

This packaging and application device 10 essentially comprises a container 14 containing the cosmetic product 12 to be applied and an application device 16 (or applicator device).

The application device 16 is for example one from:

a gloss applicator;

a mascara applicator;

an eyeshadow applicator;

a powder applicator;

a care product applicator.

The application device 16 comprises a stem 18 having a first end 18a and a second end 18b. The stem 18 extends along a longitudinal direction Xo between the first end 18a and the second end 18b of the stem 18. On FIG. 1, the longitudinal direction Xo of the stem coincides with the longitudinal direction X of the container 14 and of a handling member 20 of the application device 16, and to the longitudinal direction Xi of an applicator element 22 of the application device 16. The holding member 20 is fixed near the first end 18a of the stem 18. The applicator element 22 is mounted near the second end 18b of the stem 18, meaning in the area of this second end 18b of the stem 18. Here, the holding member 20 is substantially cylindrical. The transverse section of the holding member 20 can in particular be oval, round or polygonal, for example triangular, square or rectangular. The holding member 20, in addition to holding the application device 16, allows the attachment of this application device 16 onto the container 14. To do this, the container 14, for example of tubular shape with axis X, has a threaded neck 26 in the area of the neck 24 suited for allowing the passage of the applicator element 22 and the stem 18. The holding member 20 is itself provided with a threaded skirt 27 suited for being screwed on the threaded neck 26. This attachment thus also serves to block the neck 24. In this position of the holding member 20 on the container 14, the stem 18 allows the applicator element 22 to be received into the cosmetic product 12, thus serving to extract a portion thereof during withdrawal of the application device 16.

In the example shown, the container 14 also comprises, in the neck 24, a draining ring 28 here mounted tightened in the neck 24. This draining ring 28 is intended to come into contact with the applicator element 22 when it is withdrawn from inside the container 14, in order to eliminate excess cosmetic product 12 with which the applicator element 22 could be soaked or covered.

This draining ring 28 is however optional. Similarly, the mode of attachment of the application device 16 by screwing the holding member 20 onto the threaded neck 26 of the container 14 is only one example from other embodiments conceivable by the person skilled in the art. Alternatively, the application device 16 may be elastically nested (or “clicked”) onto the container 14.

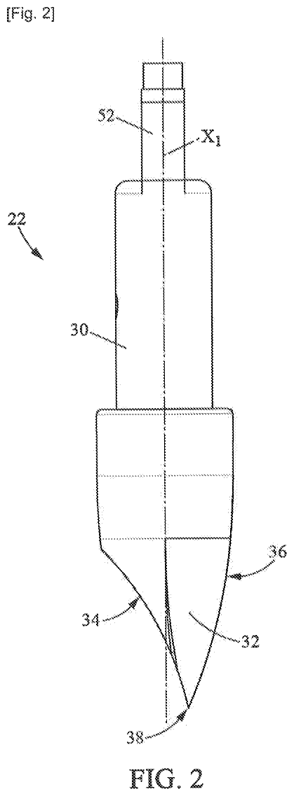

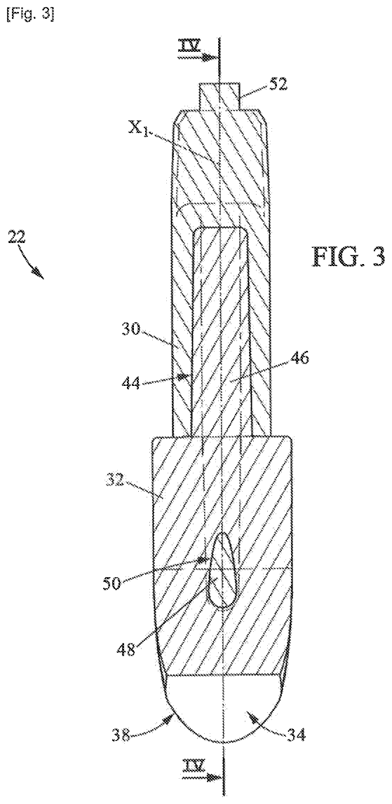

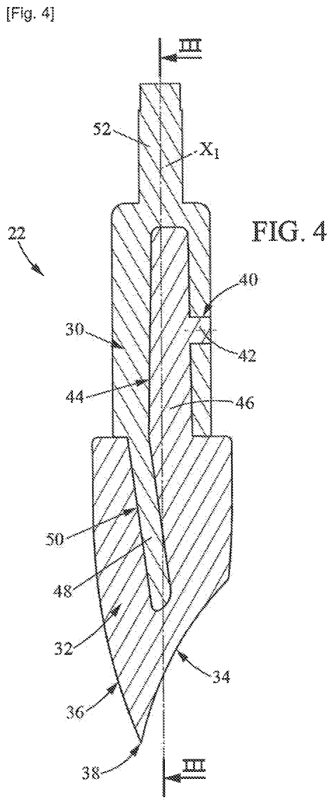

However, FIGS. 2 to 4 show the applicator element 22 of the cosmetic product application device 16 in more detail.

Remarkably, this applicator element 22 is at least partially in foamed plastic.

Here, for example, the applicator element 22 comprises a rigid head 30 (or core) onto which an application part 32 of foamed plastic is overmolded.

Here, foamed plastic is understood to mean material comprising, preferably consisting of, a gaseous phase dispersed in a solid phase of plastic. The solid plastic element constitutes the matrix. The gas phase is contained in cavities or cells. The cavities or cells may be open or closed. In closed cell foamed plastics, each cell is completely enclosed by a thin wall or membrane of plastic. In contrast, in open cell foamed plastics, the individual cells are connected to each other.

The foamed plastic from which the application part 32 is made is for example a thermoplastic elastomer. The foamed plastic is in particular selected from:

Versaflex™ CL30 thermoplastic elastomer from PolyOne™ Corporation;

TM3 ADT thermoplastic elastomer from KRAIBURG TPE;

Versaflex™ 2000x thermoplastic elastomer from PolyOne™ Corporation;

Versaflex™ PKG4365 thermoplastic elastomer from PolyOne™ Corporation;

TF5 FMA thermoplastic elastomer from KRAIBURG TPE; and

more generally, any thermoplastic which can have chemical flow readhesion with the rigid head 30.

The rigid head 30 is for example Versaflex™ CL30 thermoplastic elastomer from PolyOne™ Corporation. More generally, the rigid head 30 may be any thermoplastic which can have a chemical flow readhesion with the application part 32.

For example, the rigid head 30 has a 60 Shore A hardness whereas the application part 32 has a 10 Shore A, preferably over 30 Shore A and/or under 40 Shore A hardness. Thus a base structure for the applicator element 22 is made having sufficient hardness to provide an acceptable mechanical resistance for the applicator element, while also having a good usage comfort for a user.

The application part 32 may define one or more distinct application surfaces 34, 36, more specifically suited for cosmetic product application. In the example shown, the application part 32 is beveled so as to define two application surfaces 34, 36 made at one end of the applicator element 22. A first application surface 34 is concave, whereas the second application surface 36 is convex. The first and second application surfaces 34, 36 here meet near a far edge 38, which for example allows the execution of particularly fine lines of cosmetic product.

The application part 32 in its entirety may be covered with flocking. Alternatively, only the application surfaces 34, 36 are covered with such flocking.

The application part 32 is fixed on the rigid head 30. This attachment can be implemented by interlocking shapes and/or with the help of adhesive. A better attachment results when adhesive and interlocking shapes are used.

In the example shown, the interlocking shapes are in particular obtained because the rigid stem 30 defines a radial channel 40 opening onto the lateral surface of the rigid head 30, where this radial channel receives a pin 42 formed by the application part 32. The rigid head 30 further defines a longitudinal channel 44 receiving a portion 46, here substantially cylindrical, of the application part. The radial channel 40 opens into the longitudinal channel 44 of the rigid head 30.

The channels 40, 44 in the rigid head 30 thus form an internal connection area receiving an anchoring portion of the application part 32, formed by the pin 42 and the cylindrical portion 46.

In practice, the channels 40, 44 further allow overmolding of the application part 32 onto the rigid head 30, where the foamed plastic forming the application part is molded through these channels 40, 44.

Also, in the example shown, the rigid head 30 defines a tongue 48 of material which extends on an angle relative to the longitudinal direction of the applicator element 22, where this tongue 48 is received in a complementary housing 50 formed by the application part 32. There again, the interlocking shapes between the tongue 48 and the complementary housing 50 provide a still better attachment of the stiff head 30 and the application part 22.

In the example shown, it can be seen that the rigid head 30 forms a dog point 52 for attachment of the applicator element 22 onto the stem 18 of the application device 16. For example, the dog point 52 is received tightly in the hollow stem 18. According to a preferred implementation, the stem 18 is deformed, in particular pinched, after insertion of the dog point 52 in order to further improve the mechanical hold of the attachment of the applicator element 22 into the stem 18.

However, according to a variant not shown, the rigid head 30 is jointly molded with the stem 18. In this case, the rigid head 30 and the stem 18 are unitary.

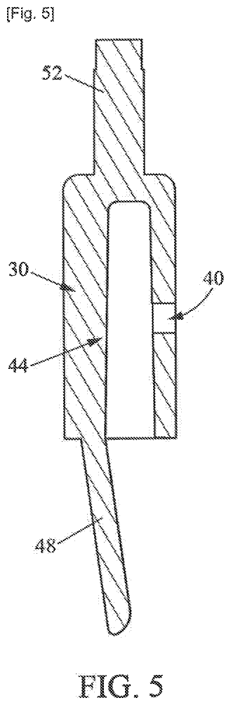

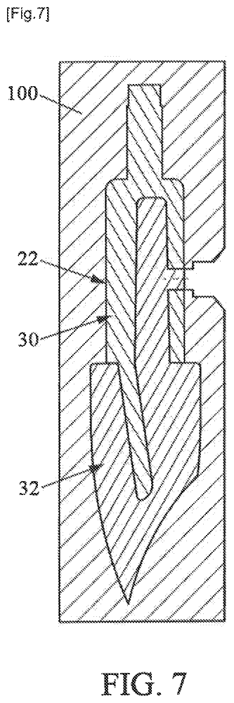

A production method example for an application device 16 as described above is now going to be described in connection with FIGS. 5 to 7 which more specifically show successive steps of implementation of the applicator element 22.

In a first step, a holding member 20 is provided. This holding member may be implemented by any means accessible to the person skilled in the art. For example, the holding member may be made by molding.

The applicator element 22 is then made. This applicator element 22 may in particular be made as follows.

First, a rigid head 30, such as described above and as can be seen in FIG. 5, is provided. Such a rigid head 30 may for example be made by plastic molding.

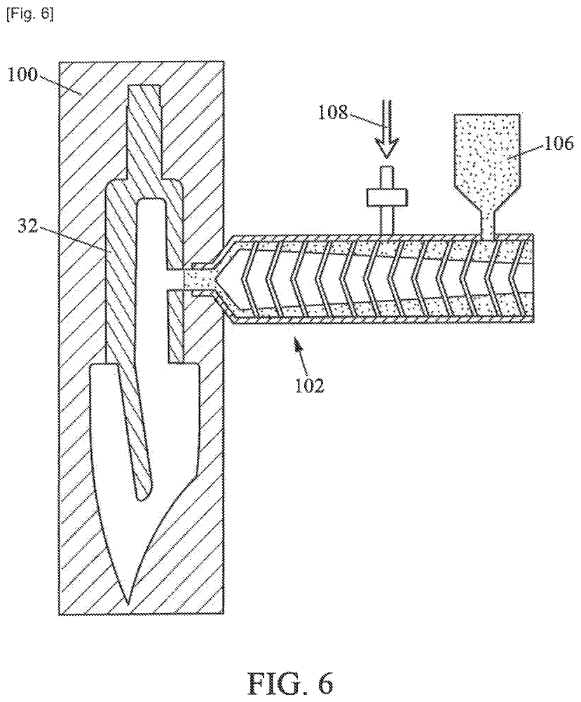

Then, as shown in FIG. 6, the rigid head 30 is arranged in a mold 100 allowing the injection of foamed plastic into the mold 100 through the radial conduit 40. The mold 100 has a receiving imprint for the rigid head 32 allowing the overmolding of the application part 22. A foamed plastic injection device 102 is arranged opposite the radial conduit 40.

A mixture of liquid plastic 106 and gas 108 can be injected into the mold 100 with the foamed plastic injection device 102.

The gas is, for example, selected from:

nitrogen; and

carbon dioxide.

Advantageously, an inert gas is implemented in this step.

The injection step may in particular last between 1 and 2 seconds. The gas injection may be done concomitantly with injection of liquid plastic, but during only a part of the liquid plastic injection. For example, the gas is injected into the mold over a time included between 1/10 of a second and ½ second, for example during ¼ second.

The quantity of foamed plastic injected into the mold may represent only a portion of the volume to be filled with said foamed plastic. In fact, it was observed that the injected foamed plastic had a tendency to continue to swell in the mold after injection thereof. This quantity of foamed plastic is for example included between 90 and 95% of the volume of the mold 100 to be filled with foamed plastic. This way a better surface condition of the applicator element 22 is provided, in particular a better appearance of the surface of the applicator element 22.

During the foamed plastic injection step, the mold 100 may be heated, in particular on one or more surfaces of the mold which define one of the application surfaces 34, 36 of the applicator element 22 or of the application part 32, as needed. It was in fact observed that it was in this way possible to get a better surface condition of these application surfaces 34, 36.

Also during the injection step, a portion of the gas present in the mold 100 may be evacuated in order to facilitate/improve the dispersion of the foamed plastic into the mold 100. In that way a more homogeneous distribution of the foamed plastic in the mold 100 is obtained and therefore a more homogeneous application part 32 as well.

Preferably, also, after the step of injection of foamed plastic into the mold 100, the mold 100 is kept in closed position for a preset time, called rest time. This rest time is for example included between 1 and 10 seconds, depending on the size of the application part. Preferably, this rest time is longer than 5 seconds. Surprisingly, it was observed that this holding of the mold in closed position limited the appearance of deformations on the molded application part 22.

After cooling and resting, as needed, the applicator element 22 is removed from the mold 100.

The applicator element 22 can then be attached to the holding member 20, via a stem 18, as needed.

The method can then be completed in order to produce a packaging and application assembly by providing a container suited to contain the cosmetic product and, preferably, containing the cosmetic product. The application device can then be fixed on the container, in particular by screwing or by elastic nesting, for example.

The invention is not limited to only the embodiments described above with respect to the figures, but is, in contrast, subject to many variants accessible to the person skilled in the art.

In particular, in the example shown, the rigid head 30 defines a single radial conduit 40. Alternatively, however, the rigid head 30 defines two radial conduits 40, in particular symmetric, extending from a single longitudinal conduit 44 or from two distinct longitudinal conduits 44, that are for example symmetric.

Also, in the example shown, the entire application part 32 is made of foamed plastic. Alternatively, however, only a portion of the application part 32 is of foamed plastic.

1. A cosmetic product application device comprising a holding member and an applicator element secured to the holding member, in which the applicator element is at least partially in foamed plastic.

2. The application device according to claim 1, wherein the applicator element is connected to the holding member by a stem.

3. The application device according to claim 1, wherein the applicator element comprises a rigid head onto which an application part of foamed plastic is overmolded.

4. The application device according to claim 3, wherein the rigid head and the application part are fixed to each other by at least one among interlocking shape and adhering.

5. The application device according to claim 4, wherein the rigid head has an internal connecting area receiving an anchoring portion of the application part.

6. The application device according to claim 5, wherein the internal connecting area of the rigid head comprises at least one channel where the at least one channel extends along a first longitudinal segment opening into a longitudinal end of the rigid head and along a second radial section, opening onto a lateral side of the rigid head.

7. The application device according to claim 3, wherein the applicator element is connected to the holding member by a stem and wherein the rigid head is jointly molded with the stem.

8. The application device according to claim 1, wherein the foamed plastic is selected from:
Versaflex™ CL30 thermoplastic elastomer from PolyOne™ Corporation;
TM3 ADT thermoplastic elastomer from KRAIBURG TPE;
Versaflex™ 2000x thermoplastic elastomer from PolyOne™ Corporation;
Versaflex™ PKG4365 thermoplastic elastomer from PolyOne™ Corporation;
TF5 FMA thermoplastic elastomer from KRAIBURG TPE; and
any thermoplastic which can have chemical flow readhesion with the rigid head, as needed.

9. The application device according to claim 1, selected from:
a gloss applicator;
a mascara applicator; and
an eyeshadow applicator.

10. A cosmetic product packaging and application assembly comprising an application device according to claim 1, and a container intended to contain a cosmetic product to be applied by means of the application device.

11. The cosmetic product packaging and application assembly according to claim 10, wherein the container contains a cosmetic product.

12. The cosmetic product packaging and application assembly according to claim 10, wherein the container has an opening and the holding member is suited to be fixed onto the container in order to block the opening of the container.

13. A method for production of an application device according to claim 1, comprising:
i) supplying a holding member;
ii) implementing the applicator element; and
iii) attaching the applicator element to the holding member;
method wherein the implementation of the applicator element comprises:
a) injecting liquid plastic and gas into a mold in order to implement a foamed plastic; and
b) after cooling, withdrawing the foamed plastic part made in step a) from the mold, where the foamed plastic part forms at least a part of the applicator element.

14. The method according to claim 13, wherein in step a), the mold is heated.

15. The method according to claim 13, wherein during step a), a portion of the gas present in the mold is evacuated.

16. The method according to claim 13, wherein the applicator element comprises a rigid head and wherein the application part in foamed plastic is overmolded on the rigid head.

17. The method according to claim 13, wherein in step a), a quantity of material less than the volume of the mold to be filled with said material is injected.

18. The method according to claim 13, comprising, after the injection step, a step of holding the mold in the closed state for a rest time at least greater than the length of the injection step.

19. The method according to claim 13, wherein the gas is selected from:
nitrogen; and
carbon dioxide.

20. A method for production of a cosmetic product packaging and application assembly according to claim 10, comprising:
the production of an application device by implementing a method according to claim 13;
supplying a container suited to contain the cosmetic product.

21. The method according to claim 20, further comprising attachment of the application device onto the container.
